(19) United States
(12) Patent Application Publication
(10) Pub. No.: US 2017/0362413 A1
(43) Pub. Date: Dec. 21, 2017

(54) TIRE SIDEWALL

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Cécile BELIN, Clermont-Ferrand Cedex 9 (FR); Olivier GONCALVES, Clermont-Ferrand Cedex 9 (FR)

(21) Appl. No.: 15/535,604

(22) PCT Filed: Dec. 14, 2015
(86) PCT No.: PCT/EP2015/079550

§ 371 Date: Jun. 13, 2017

(30) Foreign Application Priority Data
Dec. 16, 2014 (FR) 1462505

(51) Int. Cl. C08L 7/00; C08L 9/00

(52) U.S. Cl. CPC C08L 7/00; C08L 9/00

(57) ABSTRACT

A tire sidewall, having a rubber composition based on at least a blend of polyisoprene, natural rubber or synthetic polyisoprene, and polybutadiene BR, a reinforcing filler comprising carbon black and silica, and a crosslinking system is provided. The reinforcing filler predominantly comprises silica, that the content of silica ranges from 20 to 40 parts per hundred parts of elastomer, phr, and the content of carbon black is less than or equal to 5 phr and that the total content of reinforcing filler is less than or equal to 45 phr.

This application is a 371 national phase entry of PCT/EP2015/079550, filed on 14 Dec. 2015, which claims benefit of French Patent Application No. 1462505, filed 16 Dec. 2014, the entire contents of which are incorporated herein by reference for all purposes.

### BACKGROUND

### 1. Technical Field

The present invention relates to a tire sidewall based on a rubber composition, and more particularly a sidewall for tires used for civil engineering.

### 2. Related Art

The sidewalls of the tires used for civil engineering represent around 15% of the total weight of the tires, therefore a considerable weight, which, when the tread is partially worn, has a very significant impact on the rolling resistance of the tire.

It is therefore advantageous to try to reduce the hysteresis of the sidewalls of such tires in order to have an impact on the rolling resistance of these tires. However, this drop in the hysteresis should be able to be achieved without adversely affecting the other properties of the sidewall compositions, in particular mechanical properties such as the fatigue strength and the limit properties and more particularly the crack resistance.

Indeed, civil engineering tire sidewalls are subjected to very high stresses, simultaneously in terms of flexural deformation, attack and thermal stresses.

These prolonged static or dynamic stresses of the sidewalls in the presence of ozone bring out more or less pronounced crazing or cracks, the propagation of which under the effect of the persistence of the stresses may give rise to significant damage of the sidewall in question. It is therefore important that the compositions constituting tire sidewalls for civil engineering in particular have very good mechanical properties, and therefore generally a high content of reinforcing filler.

Thus, publication US2013/0112331 describes both conventional compositions for civil engineering tire sidewalls comprising, as reinforcing filler, carbon black with a content of 50 parts per hundred parts of elastomer and improved compositions having a total content of reinforcing filler of 60 phr consisting of 30 phr of carbon black and 30 phr of silica.

### SUMMARY

The applicant companies have discovered, surprisingly and contrary to the knowledge of a person skilled in the art, that weakly filled compositions predominantly based on silica made it possible to obtain sidewalls simultaneously having a reduced hysteresis while retaining very good mechanical properties.

One subject of the invention is therefore a tire sidewall, having a rubber composition based on at least a blend of polyisoprene, natural rubber or synthetic polyisoprene, and polybutadiene BR, a reinforcing filler comprising carbon black and silica, a crosslinking system, characterized in that the reinforcing filler predominantly comprises silica, that the content of silica ranges from 20 to 40 parts per hundred parts of elastomer, phr, and the content of carbon black is less than or equal to 5 phr and that the total content of reinforcing filler is less than or equal to 45 phr.

Advantageously, the total content of reinforcing filler is less than or equal to 40 phr.

Preferably, the content of silica is less than or equal to 35 phr, more preferentially the content of silica is less than or equal to 30 phr.

Advantageously, the content of natural rubber or synthetic polyisoprene ranges from 20 to 80 phr and the content of BR ranges from 20 to 80 phr.

According to one embodiment of the invention, the content of natural rubber or of synthetic polyisoprene ranges from 50 to 80 phr.

The invention lastly relates to a tire comprising a sidewall as described above, in particular a tire intended to be fitted to civil engineering vehicles.

### Measurements and Tests Used

The rubber compositions are characterized, before and after curing, as indicated below.

### Tensile Tests

These tests make it possible to determine the elasticity stresses and the properties at break; those carried out on cured mixtures are carried out in accordance with standard AFNOR-NF-T46-002 of September 1988.

At a temperature of 60° C.-2° C., and under standard hygrometry conditions (50-5% relative humidity), according to French standard NF T 40-101 (December 1979), the tensile strengths (in MPa) are measured and the elongations at break (in %) are also measured, the energy at break (breaking energy) being the product of the tensile strength and the elongation at break.

### Fatigue Test

The fatigue strength, expressed as number of cycles or in relative units (r.u.), is measured in a known manner on 12 test specimens subjected to repeated low-frequency tensile deformations up to an elongation of 75%, at 23° C., using a Monsanto (MFTR) machine until the test specimen breaks, according to the ASTM D4482-85 and ISO 6943 standards.

The result is expressed in relative units (r.u.). A value greater than that of the control, arbitrarily set at 100, indicates an improved result, that is to say a better fatigue strength of the rubber samples.

### Dynamic Property

The dynamic property tan(δ)max is measured on a viscosity analyser (Metravib VA4000) according to standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz and at a temperature of 60° C. according to standard ASTM D 1349-99, is recorded. A strain amplitude sweep is carried out from 0.1% to 50% (outward cycle) and then from 50% to 0.1% (return cycle). The result made use of is the loss factor tan d. The maximum value of tan d observed (tan(d)max) between the values at 0.1% and at 50% strain (Payne effect) are shown for the return cycle.

### DETAILED DESCRIPTION OF EXAMPLE EMBODIMENTS

In the present description, unless expressly indicated otherwise, all the percentages (%) shown are % by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### Diene Elastomer

The term “diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and can especially be described as “essentially saturated” diene elastomers (low or very low content, always less than 15%, of units of diene origin). In the category of “essentially unsaturated” diene elastomers, a “highly unsaturated” diene elastomer is understood in particular to mean a diene elastomer having a content of units of diene origin (conjugated dienes) which is greater than 50%.

Given these definitions, “diene elastomer capable of being used in the compositions in accordance with embodiments of the invention” is intended more particularly to mean:
(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, especially, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, those skilled in the art of tires will understand that the present invention is preferably employed with essentially unsaturated diene elastomers, in particular of the above type (a) or (b).

The abovementioned elastomers may have any microstructure, which depends on the polymerization conditions used, especially on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent. For coupling to carbon black, mention may for example be made of functional groups comprising a C—Sn bond or aminated functional groups, such as aminobenzophenone, for example; for coupling to a reinforcing inorganic filler such as silica, mention may for example be made of silanol functional groups or polysiloxane functional groups having a silanol end (such as described, for example, in FR 2 740 778 or U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973, WO 2009/000750 and WO 2009/000752).

As functional elastomers, mention may also be made of those prepared using a functional initiator, especially those bearing an amine or tin functional group (see, for example, WO 2010/072761).

Mention may also be made, as other examples of functionalized elastomers, of elastomers (such as SBR, BR, NR or IR) of the epoxidized type.

The elastomer matrix of the composition in accordance with embodiments of the invention comprises at least:
natural rubber, NR, or synthetic polyisoprene, preferably having a content ranging preferably from 20 phr to 80 phr,
BR, preferably with a content ranging from 20 to 80 phr.

It will be understood that “natural rubber or synthetic polyisoprene” may be only one of these elastomers or a blend of natural rubber and one or more synthetic polyisoprenes. Similarly, when reference is made to BR, it may be here one or more polybutadienes.

According to one embodiment of the invention, the content of natural rubber or of synthetic polyisoprene ranges from 50 to 80 phr, and preferably the content of BR ranges from 30 to 50 phr.

According to another embodiment of the invention, the content of BR ranges from 50 to 80 phr.

BRs having a content (mol %) of cis-1,4-linkages of greater than 90% are suitable as BR.

According to one embodiment of the invention, the composition comprises at least one other diene elastomer, preferably selected from the group consisting of butadiene-styrene copolymers (SBRs), isoprene-butadiene copolymers (BIRs), isoprene-styrene copolymers (SIRs) and isoprene-butadiene-styrene copolymers (SBIRs).

More preferably, this other diene elastomer consists of an SBR with a content preferably ranging from 10 to 30 phr, whether it is an SBR prepared in emulsion (“ESBR”) or an SBR prepared in solution (“SSBR”), or an SBR/BR, SBR/NR (or SBR/IR), BR/NR (or BR/IR) or else SBR/BR/NR (or SBR/BR/IR) blend (mixture).

The composition according to embodiments of the invention may contain another diene elastomer. The diene elastomers of the composition may be used in combination with any type of synthetic elastomer other than a diene elastomer, indeed even with polymers other than elastomers, for example thermoplastic polymers.

### Reinforcing Filler—Coupling Agent

A reinforcing filler is understood in a known manner to mean a filler known for its abilities to reinforce a rubber composition which can be used for the manufacturing of tires.

Among these reinforcing fillers are organic fillers, such as carbon black, and inorganic fillers.

The term “reinforcing inorganic filler” should be understood here to mean, in a known way, any inorganic or mineral filler, irrespective of its colour and its origin (natural or synthetic), also known as “white filler”, “clear filler” or else “non-black filler”, in contrast to carbon black, this inorganic filler being capable of reinforcing, by itself, without means other than an intermediate coupling agent, a rubber composition intended for the manufacture of a tire tread, in other words capable of replacing, in its reinforcing role, a conventional tire-grade carbon black for a tread. Such a filler is generally characterized by the presence of functional groups, especially hydroxyl (—OH) functional groups, at its surface, requiring in that regard the use of a coupling agent or system intended to provide a stable chemical bond between the elastomer and said filler.

Mention may be made, as reinforcing inorganic filler, of fillers of the siliceous type, such as silica, or of the aluminous, silica-alumina or titanium oxide type.

The reinforcing filler for the composition in accordance with embodiments of the invention comprises a blend of carbon black and silica, in which silica is predominant. Since the total content of reinforcing filler is less than or equal to 45 phr, the content of silica ranges from 20 (?) to 40 phr and the content of carbon black is less than or equal to 5 phr.

Preferably, the total content of reinforcing filler is less than or equal to 40 phr, more preferentially the content of silica is less than or equal to 35 phr and more preferentially still less than or equal to 30 phr.

All reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N400, N660, N683 or N772), are suitable as carbon blacks. The carbon blacks might, for example, be already incorporated in the isoprene elastomer in the form of a masterbatch (see, for example, patent applications WO 97/36724 or WO 99/16600).

The silica used may be any reinforcing silica known to a person skilled in the art, in particular any precipitated or fumed silica having a BET surface area and also a CTAB specific surface area both of less than 450 m²/g, preferably from 30 to 400 m²/g, in particular between 60 and 300 m²/g. As highly dispersible precipitated silicas (“HDSs”), mention will be made, for example, of the Ultrasil 7000 and Ultrasil 7005 silicas from Degussa, the Zeosil 1165MP, Zeosil 1135MP, Zeosil 1115MP and Zeosil Premium 200 MP silicas from Rhodia, the Hi-Sil EZ150G silica from PPG, the Zeopol 8715, 8745 and 8755 silicas from Huber and the silicas having a high specific surface area as described in application WO 03/016387.

It is specified that the CTAB specific surface area is determined according to French standard NF T 45-007 of November 1987 (method B).

As reinforcing inorganic filler, mention will also be made of mineral fillers of the aluminous type, in particular alumina (Al₂O₃) or aluminium (oxide)hydroxides, or else reinforcing titanium oxides, for example described in U.S. Pat. No. 6,610,261 and U.S. Pat. No. 6,747,087.

The physical state in which the reinforcing inorganic filler is provided is unimportant, whether it is in the form of a powder, microbeads, granules or else beads. Of course, reinforcing inorganic filler is also understood to mean mixtures of various reinforcing inorganic fillers, in particular of highly dispersible silicas as described above.

In order to couple the reinforcing inorganic filler, in particular silica, to the diene elastomer, use is made, in a known manner, of an at least bifunctional coupling agent (or bonding agent) intended to provide a sufficient connection, of chemical and/or physical nature, between the inorganic filler (surface of its particles) and the diene elastomer, in particular bifunctional organosilanes or polyorganosiloxanes.

The content of coupling agent is advantageously less than 20 phr, it being understood that it is generally desirable to use as little as possible thereof. Typically, the content of coupling agent represents from 0.5% to 15% by weight, with respect to the amount of inorganic filler. Its content is preferentially between 0.5 and 12 phr, more preferentially within a range extending from 2 to 10 phr. This content is easily adjusted by those skilled in the art depending on the content of inorganic filler used in the composition.

### Crosslinking System

The crosslinking system is preferably a vulcanization system, that is to say a system based on sulphur (or on a sulphur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), are added to this base vulcanization system, being incorporated during the first non-productive phase and/or during the productive phase, as described subsequently.

The sulphur is used at a preferred content of between 0.5 and 10 phr, more preferentially of between 1 and 8 phr, in particular between 1 and 6 phr, when the composition of embodiments of the invention is intended, according to a preferred form of the invention, to constitute an internal “gum” (or rubber composition) of a tire. The primary vulcanization accelerator is used at a preferential content of between 0.5 and 10 phr, more preferentially of between 0.5 and 5.0 phr.

Use may be made, as accelerator, of any compound capable of acting as accelerator for the vulcanization of diene elastomers in the presence of sulphur, in particular accelerators of the thiazole type, and also their derivatives, and accelerators of thiuram and zinc dithiocarbamate types. These primary accelerators are more preferably selected from the group consisting of 2-mercaptobenzothiazole disulphide (abbreviated to “MBTS”), N-cyclohexyl-2-benzothiazole sulphenamide (abbreviated to “CBS”), N,N-dicyclohexyl-2-benzothiazole sulphenamide (abbreviated to “DCBS”), N-(tert-butyl)-2-benzothiazole sulphenamide (abbreviated to “TBBS”), N-(tert-butyl)-2-benzothiazole sulphenimide (abbreviated to “TBSI”) and the mixtures of these compounds.

### Other Constituents

The rubber matrices of the composites in accordance with embodiments of the invention also comprise all or some of the additives customarily used in the rubber compositions intended for the manufacture of tires, such as for example anti-ageing agents, antioxidants, plasticizers or extender oils, whether the latter are of aromatic or non-aromatic nature, in particular very weakly aromatic or non-aromatic oils (e.g., naphthenic or paraffinic oils, MES or TDAE oils), agents that improve the processability of the compositions in the uncured state, anti-reversion agents such as for example sodium hexathiosulphonate or N,N′-m-phenylene-biscitraconimide, methylene acceptors and donors (for example resorcinol, HMT or H3M), or metal salts such as for example organic salts of cobalt or nickel.

Those skilled in the art will know how to adjust the formulation of the composition depending on their specific requirements.

### Manufacture of the Rubber Compositions

The rubber compositions of embodiments of the invention are manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 40° C. and 100° C., during which finishing phase the crosslinking or vulcanization system is incorporated.

The final composition thus obtained is subsequently calendered, for example in the form of a sheet or slab, in particular for laboratory characterization, or else extruded, in order to form, for example, a rubber profiled element used in the manufacture of semi-finished products, such as tire sidewalls.

The vulcanization (or curing) is carried out in a known way at a temperature generally of between 130° C. and 200° C., for a sufficient time which can vary, for example, between 5 and 90 min, as a function especially of the curing temperature, of the vulcanization system adopted and of the vulcanization kinetics of the composition under consideration.

The examples which follow illustrate the invention without, however, limiting it.

### EXEMPLARY EMBODIMENTS

### Preparation of the Rubber Compositions

The following tests are carried out in the following way: the diene elastomer (NR and BR blend), the silica, supplemented by a small amount of carbon black, the coupling agent and then, after kneading for one to two minutes, the various other ingredients, with the exception of the vulcanization system, are introduced into an internal mixer which is 70% filled and which has an initial vessel temperature of approximately 90° C. Thermomechanical working is then carried out (non-productive phase) in one stage (total duration of the kneading equal to approximately 5 min), until a maximum “dropping” temperature of approximately 165° C. is reached. The mixture thus obtained is recovered and cooled and then the covering agent (when the latter is present) and the vulcanization system (sulphur and sulphenamide accelerator) are added on an external mixer (homofinisher) at 70° C., everything being mixed (productive phase) for approximately 5 to 6 min.

The compositions thus obtained are subsequently calendered, either in the form of slabs (thickness of 2 to 3 mm) or of thin sheets of rubber, for the measurement of their physical or mechanical properties, or in the form of profiled elements which can be used directly, after cutting and/or assembling to the desired dimensions, for example as semi-finished products for tires, in particular as tire sidewalls.

### Tests

The purpose of this example is to show the improvement of tire sidewalls in accordance with embodiments of the invention relative to sidewalls of a “conventional” control tire for a civil engineering vehicle.

The tire sidewall compositions were manufactured in accordance with the process described in detail in the previous section. These compositions listed in the following Table 1 (where the amounts are expressed in phr, parts by weight per hundred parts of elastomer) differ by the nature and the amount of their respective reinforcing filler, and also by the amount of plasticizer used.

The formulations are presented in the following Table 1.

TABLE 1

| Composition: | A | B | C |
|---|---|---|---|
| NR (1) | 50 | 50 | 50 |
| BR (2) | 50 | 50 | 50 |
| Carbon black (3) | — | — | — |
| Carbon black (4) | 38 | 32 | 3 |
| Silica (5) | — | — | 29 |
| Coupling agent (6) | — | — | 3 |
| Plasticizer (7) | 10 | 10 | 10 |
| Wax | 1 | 1 | 1 |
| Antioxidant (8) | 3 | 3 | 3 |
| ZnO | 2.5 | 2.5 | 2.5 |
| Stearic acid | 1 | 1 | 1 |
| Sulphur | 1 | 1 | 1 |
| Accelerator (9) | 0.8 | 0.8 | 0.8 |

(1) Natural rubber;
(2) BR with 0.5% of 1,2-; 1 to 1.5% of trans; 98% of cis-1,4-(Tg = −108° C.);
(3) Carbon black N234 sold by Cabot Corporation;
(4) Silica, Zeosil 1165MP sold by Rhodia;
(5) Coupling agent TESPT (Si69 from Degussa);
(6) TDAE oil, Vivatec 500 from Klaus Dahleke;
(7) N-(1,3-Dimethylbutyl)-N-phenyl-para-phenylenediamine (Santoflex 6-PPD from Flexsys);
(8) N-Cyclohexyl-2-benzothiazole sulphenamide (Santocure CBS from Flexsys).

The compositions A, B and C are thus defined as follows:
the control composition A is a “conventional” civil engineering vehicle tire sidewall composition including a carbon black of 200 grade,
the composition B not in accordance with embodiments of the invention is a composition similar to the composition A, in which the content of carbon black has been significantly reduced,
the composition C in accordance with embodiments of the invention is a composition having a total content of reinforcing filler identical to that of the composition B but that comprises a content of carbon black of 3 phr and silica as predominant reinforcing filler.

The rubber properties of these three compositions are measured before curing and after curing at 150° C. for 60 minutes; the results obtained are given in Table 2.

TABLE 2

| Composition: | A | B | C |
|---|---|---|---|
| Elongation at break (%) | 762 | 809 | 811 |
| Tensile strength (MPa) | 11.9 | 12 | 11 |
| MFTR | 58 | 48 | 92 |
| tanδₘₐₓ | 0.139 | 0.128 | 0.120 |

It is observed that the three compositions have equivalent limit properties at break (values of the elongations at break and tensile strengths).

However, the fact of significantly reducing the content of reinforcing filler between the “conventional” control composition A (38 phr of carbon black) and the composition B (32 phr of carbon black) makes the fatigue strength property (MFTR) drop very greatly, even though the hysteresis results show a positive reduction. This very high drop in fatigue strength is an effect expected by a person skilled in the art as a consequence of the very great reduction in the content of reinforcing filler.

Yet on the contrary, astonishingly it is observed that the composition C in accordance with embodiments of the invention that has, like the composition B, a very low total content of reinforcing filler (but with silica predominant), nevertheless makes it possible to obtain a fatigue strength practically much higher than that of the composition B, but also much higher than that of the control composition A.

Furthermore, the composition C in accordance with embodiments of the invention makes it possible to further lower the hysteresis relative to the composition B (which already had a significantly reduced hysteresis compared to the control composition A).

1. A tire sidewall, having a rubber composition based on at least a blend of polyisoprene, natural rubber or synthetic polyisoprene, and polybutadiene BR, a reinforcing filler comprising carbon black and silica, and a crosslinking system, wherein the reinforcing filler predominantly comprises silica, the content of silica ranges from 20 to 40 parts per hundred parts of elastomer, phr, and the content of carbon black is less than or equal to 5 phr, and the total content of reinforcing filler is less than or equal to 45 phr.

2. A tire sidewall according to claim 1, in which the total content of reinforcing filler is less than or equal to 40 phr.

3. A tire sidewall according to claim 1, in which the content of silica is less than or equal to 35 phr.

4. A tire sidewall according to claim 3, in which the content of silica is less than or equal to 30 phr.

5. A tire sidewall according to claim 1, in which the content of natural rubber or of synthetic polyisoprene ranges from 20 to 80 phr and the content of BR ranges from 20 to 80 phr.

6. A tire sidewall according to claim 5, in which the content of natural rubber or of synthetic polyisoprene ranges from 50 to 80 phr.

7. A tire sidewall according to claim 5, in which the content of BR ranges from 30 to 50 phr.

8. A tire sidewall according to claim 1, in which the content of BR ranges from 50 to 80 phr.

9. A tire comprising a sidewall according to claim 1.

10. A tire intended to be fitted to civil engineering vehicles comprising a sidewall according to claim 1.
